(19) United States
(12) Patent Application Publication
(10) Pub. No.: US 2013/0170420 A1
(43) Pub. Date: Jul. 4, 2013

(54) WIRELESS COMMUNICATION DEVICE, WIRELESS COMMUNICATION METHOD AND PROCESSING CIRCUIT

(71) Applicant: Hirokazu Kobayashi, Tokyo (JP)

(72) Inventor: Hirokazu Kobayashi, Tokyo (JP)

(73) Assignee: PANASONIC CORPORATION, Osaka (JP)

(21) Appl. No.: 13/821,461

(22) PCT Filed: Sep. 14, 2011
(86) PCT No.: PCT/JP2011/005188

§ 371 Date: Mar. 7, 2013

(30) Foreign Application Priority Data
Oct. 7, 2010 (JP) 2010-227695

(51) Int. Cl. H04W 52/02

(52) U.S. Cl. CPC H04W 52/0229
USPC 370/311

(57) ABSTRACT

Provided is a wireless communication device capable of setting an appropriate transmission power flexibly in accordance with the surrounding environment when returning to a normal power mode from a low power mode. In the wireless communication device (100), during operation in an awake mode a reception quality recording unit (120) records a first reception quality which is a reception signal quality from an AP to be connected, and a second reception quality which is a reception signal quality from an AP not to be connected. A variation determination unit (130) determines a difference between the first reception quality and the second reception quality. An initial value setting unit (150) sets an initial value of the transmission power of an awake notification signal transmitted when starting operation in the awake mode next time on the basis of the difference between the first reception quality and the second reception quality.

### TECHNICAL FIELD

The claimed invention relates to a radio communication apparatus, a radio communication method, and a processing circuit that operate in a power saving mode.

### BACKGROUND ART

Radio communication systems have been widely used as data communication means out of convenience, for example, of not being limited by locations where they are used.

An example of radio communication systems is a wireless LAN (Local Area Network) system defined in IEEE802.11. A wireless LAN system is provided with an ad hoc mode and an infrastructure mode to perform communication with other communication apparatuses.

In the ad hoc mode, wireless LAN terminals directly exchange data with each other. The infrastructure mode is constructed of a radio communication apparatus called “access point” (hereinafter, abbreviated as “AP”) and a wireless LAN terminal connected to the AP to perform communication with other communication apparatuses. Data from a wireless LAN terminal to another communication apparatus is transferred via the AP and data from the other communication apparatus to the wireless LAN terminal is delivered via the AP.

In such a radio communication system, portable type communication terminals are often used. Portable type communication terminals are battery driven, and so they are required to meet power saving characteristics.

In an IEEE802.11-based wireless LAN system, a specification relating to a power-saving mode to suppress power consumption is defined as described, for example, in Non-Patent Literature 1.

In the power-saving mode, the wireless LAN terminal has two modes: an awake mode that allows data transmission/reception and a doze mode in which the wireless LAN terminal operates with low power without performing transmission/reception. The awake mode is also called “normal power mode.” On the other hand, the doze mode is also called “low power operating mode (low power mode).”

The time domain in which the wireless LAN terminal operates in the awake mode is called “awake period.” On the other hand, the time domain in which the wireless LAN terminal operates in the doze mode is called “doze period.” Thus, in the power-saving mode, the time domain is divided into the awake period and the doze period, and the wireless LAN terminal is operated with saved power for the doze period during which transmission/reception is not performed. That is, the power-saving mode is intended to achieve power saving from the temporal perspective.

To be more specific, the wireless LAN terminal operating in the power-saving mode shifts to the doze mode at intervals of beacon frames periodically transmitted by the AP. When the wireless LAN terminal receives a beacon signal including a TIM (Traffic Indication Map) indicating that there is data addressed to the wireless LAN terminal, the wireless LAN terminal transmits an awake notification signal indicating a data delivery request to the AP. Thus, the wireless LAN terminal notifies the AP that it has shifted to the awake mode and receives data thereafter.

Of the awake period, a period after the wireless LAN terminal notifies the AP of the awake notification signal until it receives an acknowledgment signal in response to the awake notification signal from the AP is called “awake notification period.”

Upon receiving data addressed to the wireless LAN terminal under the control of the AP, the AP temporarily saves the data in a communication buffer. When the destination wireless LAN terminal is operating in the awake mode, the AP transfers the data. When the wireless LAN terminal is operating in the doze mode, the AP sets corresponding bits of a TIM indicating that data for the wireless LAN terminal is buffered and transmits a beacon signal including the TIM.

As a conventional example of processing of shifting from the awake mode to the doze mode, Patent Literature 1 describes a technique of transmitting to the AP, a signal notifying the AP that the mode will be shifted to the doze mode. When the AP indicates that there is no data addressed to the wireless LAN terminal and when the wireless LAN terminal determines that there is no data to be transmitted/received by the wireless LAN terminal, the wireless LAN terminal determines that the mode will be shifted to the doze mode. The wireless LAN terminal then transmits to the AP, a doze notification signal for notifying the AP that the mode will be shifted to the doze mode, and shifts to the doze mode again.

Furthermore, as another example of prior art for suppressing power consumption, for example, Patent Literature 2 describes a technique of reducing power consumption during transmission by wirelessly communicating with spatially necessary minimum transmission power. The apparatus described in Patent Literature 2 estimates a distance between the AP and the apparatus based on a beacon signal received from the AP and determines transmission power based on the estimated distance. The apparatus described in Patent Literature 2 transmits a connection request signal to establish a wireless LAN connection while gradually increasing the determined transmission power and performs subsequent communication with transmission power that enables a response from the AP.

### CITATION LIST

### Patent Literature

PTL 1
Japanese Patent Application Laid-Open No. 2007-19607
PTL 2
Japanese Patent Application Laid-Open No. 2005-328231

### Non-Patent Literature

NPL 1
IEEE Std802.11-2007, Part11: Wireless LAN Medium Access Control (MAC) and Physical Layer (PHY) Specifications, Jun. 12, 2007 (P425-P436)

### SUMMARY OF INVENTION

### Technical Problem

However, the techniques described in Non-Patent Literature 1 and Patent Literature 1 make no reference to the optimization of transmission power to achieve power saving from the spatial perspective. For this reason, even if the wireless LAN terminal is located in an environment in which it can keep a good connection with the AP, the wireless LAN terminal performs communication with constant transmission power. As a result, the wireless LAN terminal may perform transmission with more than necessary transmission power and has a problem of consuming power uselessly.

Furthermore, according to the technique described in Patent Literature 2, upon establishing a wireless LAN connection, the wireless LAN terminal determines minimum transmission power and performs subsequent communication with the determined transmission power. Thus, the technique described in Patent Literature 1 has a problem that it is difficult to flexibly respond to movement of the wireless LAN terminal and to a change in the surrounding environment.

It is an object of the claimed invention to provide a radio communication apparatus, a radio communication method, and a processing circuit capable of flexibly setting appropriate transmission power according to the surrounding environment upon returning from a low power mode to a normal power mode.

### Solution to Problem

A radio communication apparatus according to one aspect of the claimed invention is a radio communication apparatus that operates in a low power mode during no communication and operates in a normal power mode when there is data to be received or transmitted, including: a recording section that records first receiving quality which is received signal quality from a connected access point during operation in the normal power mode and second receiving quality which is received signal quality from an access point other than the connected access point; a determining section that determines a difference between the first receiving quality and the second receiving quality; and a setting section that sets an initial value of transmission power of an awake notification signal transmitted when starting operation in the next normal power mode based on the difference.

According to this configuration, when the radio communication apparatus operates in the low power mode during no communication and operates in the normal power mode when there is data to be transmitted/received, the radio communication apparatus can set appropriate transmission power upon returning from the low power mode to the normal power mode. This allows the radio communication apparatus of the claimed invention to prevent communication with excessive transmission power while securing communication quality, and can thereby suppress power consumption of the radio communication apparatus.

The radio communication apparatus according to another aspect of the claimed invention further includes a transmission power determining section that determines transmission power of the awake notification signal that enables a response from the connected access point as the transmission power in the normal power mode.

According to this configuration, even when the radio communication apparatus sets an excessively small initial value of transmission power, the transmission power can be modified to appropriate transmission power. This allows the radio communication apparatus of the claimed invention to prevent communication with excessive transmission power while securing communication quality, and can thereby suppress power consumption of the radio communication apparatus.

In the radio communication apparatus according to a further aspect of the claimed invention, the setting section modifies the initial value to a smaller value when shifting from the low power mode to the normal power mode and when the latest difference determined by the determining section is improved from the last difference.

According to this configuration, upon returning from the low power mode to the normal power mode, the radio communication apparatus can set appropriate transmission power even when communication environment changes. This allows the radio communication apparatus of the claimed invention to prevent communication with excessive transmission power while securing communication quality, and can thereby suppress power consumption of the radio communication apparatus.

In the radio communication apparatus according to a still further aspect of the claimed invention, the setting section further sets, when shifting from the normal power mode to the low power mode and when the latest difference calculated by the determining section is improved from the last difference, transmission power of a doze notification signal notifying the shift to the low power mode to a value smaller than the transmission power in the normal power mode.

According to this configuration, when shifting to the low power mode in the event of communication interruption, the latest receiving quality situation can be reflected in the determination of the next transmission power. Thus, when determining transmission power in the normal power mode, even when the receiving quality temporarily deteriorates and the transmission power in the normal power mode is set to a high value, the transmission power in the next normal power mode can be set appropriately. This allows the radio communication apparatus of the claimed invention to prevent communication with excessive transmission power while securing communication quality, and can thereby suppress power consumption of the radio communication apparatus.

A radio communication method according to a still further aspect of the claimed invention is a radio communication method for a radio communication apparatus that operates in a low power mode during no communication and operates in a normal power mode when there is data to be received or transmitted, the method including: recording first receiving quality which is received signal quality from a connected access point during operation in the normal power mode and second receiving quality which is received signal quality from an access point other than the connected access point; determining a difference between the first receiving quality and the second receiving quality; and setting an initial value of transmission power of an awake notification signal transmitted when starting operation in the next normal power mode based on the difference.

According to this configuration, when operating in the low power mode during no communication and when operating in the normal power mode when there is data to be transmitted/received, the radio communication method can set appropriate transmission power upon returning from the low power mode to the normal power mode. This allows the radio communication method of the claimed invention to prevent communication with excessive transmission power while securing communication quality, and can thereby suppress power consumption involved in radio communication.

A radio communication method according to a still further aspect of the claimed invention is a radio communication method for a radio communication apparatus that operates in a low power mode during no communication and operates in a normal power mode when there is data to be received or transmitted, the method including: recording first receiving quality which is received signal quality from a connected access point during operation in the normal power mode and second receiving quality which is received signal quality from an access point other than the connected access point; determining a difference between the first receiving quality and the second receiving quality; setting an initial value of transmission power of an awake notification signal transmitted when starting operation in the normal power mode based on the difference; determining transmission power of the awake notification signal that enables a response from the connected access point as transmission power in the normal power mode; and modifying an initial value of transmission power of an awake notification signal transmitted when starting operation in the next normal power mode to a smaller value when the difference between the first receiving quality and the second receiving quality is improved from the last difference.

According to this configuration, when operating in the low power mode during no communication and when operating in the normal power mode when there is data to be transmitted/received, the radio communication method sets appropriate transmission power even if a communication environment changes upon returning from the low power mode to the normal power mode. This allows the radio communication method of the claimed invention to prevent communication with excessive transmission power while securing communication quality, and can thereby suppress power consumption involved in radio communication.

A processing circuit according to a still further aspect of the claimed invention is a processing circuit of a radio communication apparatus that operates in a low power mode during no communication and operates in a normal power mode when there is data to be received or transmitted, including: a section that records first receiving quality which is received signal quality from a connected access point during operation in the normal power mode and second receiving quality which is received signal quality from an access point other than the connected access point; a section that determines a difference between the first receiving quality and the second receiving quality; and a section that sets an initial value of transmission power of an awake notification signal transmitted when starting operation in the normal power mode, in which the processing circuit performs control of modifying an initial value of transmission power of a next awake notification signal based on the difference between the first receiving quality and the second receiving quality.

According to this configuration, when operating in the low power mode during no communication and when operating in the normal power mode when there is data to be transmitted/received, the processing circuit can set appropriate transmission power upon returning from the low power mode to the normal power mode. This allows the radio communication method of the claimed invention to prevent communication with excessive transmission power while securing communication quality, and can thereby suppress power consumption of the processing circuit.

### Advantageous Effects of Invention

According to the claimed invention, it is possible to provide a radio communication apparatus, a radio communication method and a processing circuit capable of flexibly setting appropriate transmission power according to a surrounding environment upon returning from a low power mode to a normal power mode.

### BRIEF DESCRIPTION OF DRAWINGS

FIG. 1 is a block diagram illustrating a configuration of a radio communication apparatus according to Embodiment 1 of the claimed invention;

FIG. 2 is a diagram illustrating a configuration example of a received signal quality table;

FIG. 3 is a diagram illustrating a flow of determining an initial value to set the next awake notification power;

FIG. 4 is a diagram illustrating a flow of finally determining awake notification power for an awake period this time and transmission power during communication;

FIG. 5 is a diagram illustrating an example of a network configuration according to Embodiment 1;

FIG. 6 is a diagram illustrating a sequence example when the radio communication apparatus according to Embodiment 1 communicates with an AP;

FIG. 7 is a diagram illustrating another sequence example when the radio communication apparatus according to Embodiment 1 communicates with an AP; and

FIG. 8 is a diagram illustrating a flow of shifting from an awake mode to a doze mode in Embodiment 2 of the claimed invention.

### DESCRIPTION OF EMBODIMENTS

Hereinafter, embodiments of the claimed invention will be described in detail with reference to the accompanying drawings.

### Embodiment 1

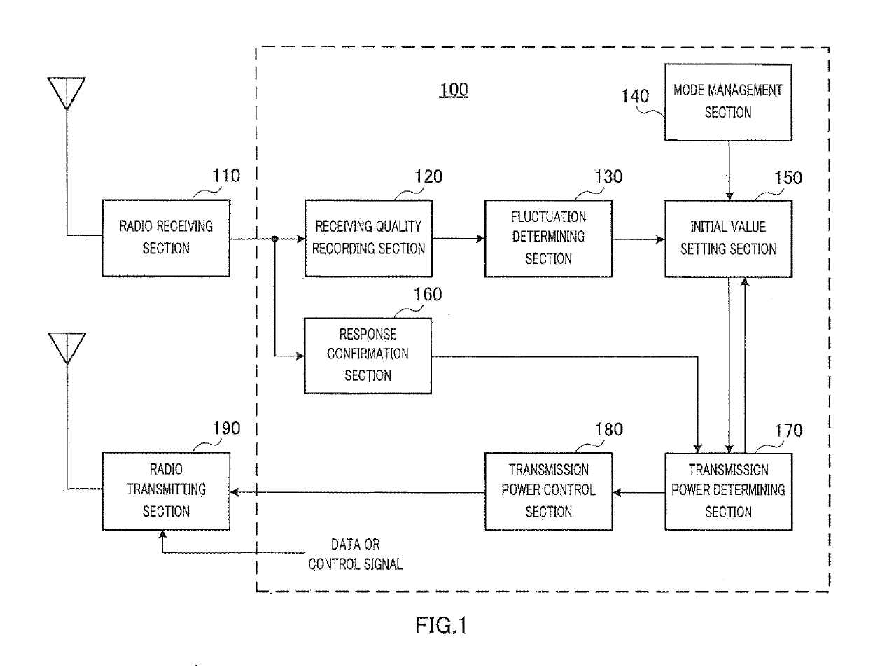

FIG. 1 is a block diagram illustrating a configuration of a radio communication apparatus according to the present embodiment.

In FIG. 1, radio communication apparatus 100 includes radio receiving section 110, receiving quality recording section 120, fluctuation determining section 130, mode management section 140, initial value setting section 150, response confirmation section 160, transmission power determining section 170, transmission power control section 180, and radio transmitting section 190.

Though not shown in FIG. 1, radio communication apparatus 100 may include a user interface for a user to select and perform operation of radio communication apparatus 100.

Examples of the user interface include a key, display, codec, microphone, speaker, camera, vibrator, memory for storing and executing a program or the like.

In the above-described configuration, for example, the portion excluding radio receiving section 110 and radio transmitting section 190 (portion enclosed by a broken line) may be implemented by a processing circuit (not shown) provided for radio communication terminal 100.

Furthermore, radio communication apparatus 100 according to the present embodiment has two modes: an awake mode (normal power mode) in which data can be transmitted/received and a doze mode (low power operating mode) in which the apparatus operates with low power without performing transmission/reception.

Radio receiving section 110 performs radio reception processing (down-conversion, A/D (Analog to Digital) conversion, demodulation or the like) on a received signal received via a receiving antenna. Radio receiving section 110 then outputs the acquired received signal to receiving quality recording section 120 and response confirmation section 160.

Receiving quality recording section 120 determines and records receiving quality of the received signal demodulated by radio receiving section 110. To be more specific, receiving quality recording section 120 acquires receiving quality of a beacon signal that can be received from an AP located in the periphery during an awake period, and records the acquired receiving quality.

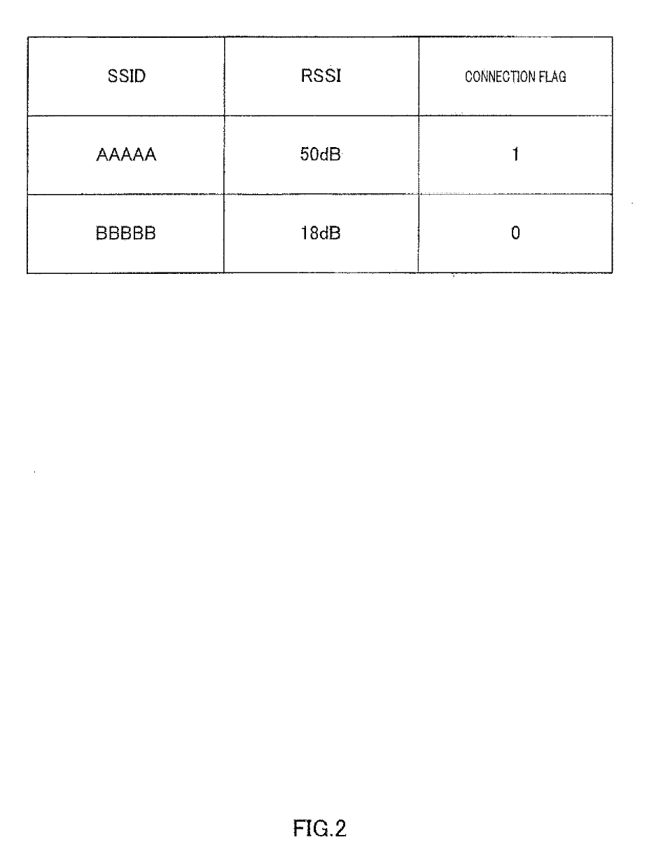

FIG. 2 shows an example of a received signal quality table recorded by receiving quality recording section 120.

The received signal quality table includes an SSID (Service Set IDentifier), RSSI (Received Signal Strength Indication) and connection flag. The SSID is an entry that identifies an AP. The RSSI is an entry that indicates receiving quality. The connection flag is an entry that indicates to which AP radio communication apparatus 100 is connected. Radio communication apparatus 100 is connected to an AP whose connection flag is 1.

FIG. 2 shows an example where radio communication apparatus 100 is connected to an AP whose SSID is AAAAA and whose received signal strength is 50 dB. Furthermore, FIG. 2 shows that another AP exists in the periphery in addition to the connected AP. FIG. 2 shows an example where the SSID of the AP is BBBBB and the received signal strength thereof is 18 dB.

The entries of the aforementioned received signal quality table are examples, and the entries can be anything as long as identification of an AP is associated with receiving quality and recorded in receiving quality recording section 120. Therefore, in the received signal quality table, a MAC (Media Access Control) address of an AP may be an entry instead of the SSID. Furthermore, in the received signal quality table, the RSSI may be expressed in percentage instead of dB.

Fluctuation determining section 130 determines a difference between received signal quality from the connected AP and received signal quality from an AP other than the connected AP. To be more specific, fluctuation determining section 130 compares between received signal qualities in the received signal quality table recorded in receiving quality recording section 120 to calculate the difference. Fluctuation determining section 130 determines whether the difference between the received signal quality from the connected AP and received signal quality from an AP other than the connected AP is large or not. When, for example, the difference is 20 dB or higher, fluctuation determining section 130 determines that the difference is large. In the example in FIG. 2, the difference in received signal strength is 32 dB, which is larger than a threshold of 20 dB. For this reason, fluctuation determining section 130 determines that the difference is large.

Furthermore, fluctuation determining section 130 determines whether the width of difference has expanded or diminished from the last determination of difference in addition to the determination of the degree (magnitude) of the difference in received signal quality. For example, when the difference at the last determination is 22 dB and the difference at the latest determination is 32 dB, fluctuation determining section 130 determines that the difference is large and the width of difference has expanded.

Here, the “expansion of the width of difference” means that the received signal quality from the connected AP has improved. For this reason, the width of difference is based on the received signal quality from the connected AP.

Thus, when the received signal strength from the connected AP is higher than the received signal strength from the other AP and the difference between the increases, fluctuation determining section 130 determines that the width of difference has expanded. On the other hand, when the received signal strength from the connected AP is lower than the received signal strength from the other AP and the difference between the received signal strengths decreases, fluctuation determining section 130 determines that the width of difference has expanded.

Fluctuation determining section 130 outputs information on the difference in received signal quality between the connected AP and the AP other than the connected AP (hereinafter, referred to as “inter-AP receiving quality difference”) to initial value setting section 150.

Initial value setting section 150 sets an initial value of transmission power of an awake notification signal (hereinafter, referred to as “awake notification power”). The awake notification signal is a signal notified of by radio communication apparatus 100 to the connected AP upon shifting from a doze mode to an awake mode. To be more specific, initial value setting section 150 sets an initial value of awake notification power based on the information of the transmission power at the last communication acquired from transmission power determining section 170 and the information of the inter-AP receiving quality difference acquired from fluctuation determining section 130. The method of setting an initial value of awake notification power will be described later.

Mode management section 140 manages the operation state of radio communication apparatus 100. To be more specific, mode management section 140 manages the shift to a doze mode or the shift to an awake mode. When shifting to the awake mode, mode management section 140 notifies initial value setting section 150 of the shift to the awake mode and requests initial value setting section 150 to set an initial value of the awake notification power.

Furthermore, mode management section 140 also manages whether data to be transmitted/received after the shift to the awake mode is high-priority data or not. Mode management section 140 monitors, for example, a TIM field for QoS (Quality of Service) in a received beacon signal, and can thereby determine whether the received data is high-priority data or not. Furthermore, mode management section 140 can determine whether transmission data is high-priority data or not depending on whether the transmission data is placed in a high-priority transmission queue or not.

In response to an awake notification signal transmitted with the awake notification power determined in transmission power determining section 170, which will be described later, response confirmation section 160 determines whether an acknowledgment signal which is a response thereto has been acquired from the connected AP or not. Here, the acknowledgment signal is a response signal notified of from the AP when the AP receives the awake notification signal transmitted from radio communication apparatus 100. Response confirmation section 160 notifies transmission power determining section 170 of the determination result indicating the presence or absence of an acknowledgment signal.

Transmission power determining section 170 determines the actual transmission power of the awake notification signal and a transmission signal (data or control signal) in the awake mode based on the initial value of the awake notification power and the difference in the receiving quality. Transmission power determining section 170 instructs transmission power control section 180 to transmit an awake notification signal or transmission signal with the determined transmission power.

When an acknowledgment signal for the awake notification signal transmitted with the determined awake notification power is obtained from the connected AP, transmission power determining section 170 determines this awake notification power as the transmission power during communication.

Transmission power determining section 170 instructs transmission power control section 180 to transmit data and a control signal with the set transmission power.

On the other hand, when the acknowledgment signal for the awake notification signal is not obtained, transmission power determining section 170 increases the awake notification power and resets the awake notification power. When the acknowledgment signal for the awake notification signal transmitted with the reset awake notification power is not obtained, transmission power determining section 170 further increases the awake notification power and further sets the reset awake notification power. When response confirmation section 160 receives an acknowledgment signal for the awake signal, transmission power determining section 170 sets the awake notification power that allows an acknowledgment signal to be obtained, as the transmission power during communication.

After setting the transmission power during communication, transmission power determining section 170 notifies initial value setting section 150 of the transmission power set value information indicating the transmission power. Furthermore, transmission power determining section 170 notifies transmission power control section 180 of an instruction regarding the determined transmission power.

Transmission power control section 180 controls transmission power of a signal transmitted by radio communication apparatus 100. To be more specific, transmission power control section 180 receives the instruction regarding transmission power from transmission power determining section 170 and instructs radio transmitting section 190 to transmit a signal with the corresponding transmission power.

Radio transmitting section 190 performs radio transmission processing (modulation, D/A (Digital to Analog) conversion, up-conversion or the like) on data or a control signal and transmits a transmission signal via a transmitting antenna.

Operation of radio communication apparatus 100 configured as shown above will be described.

[Determining Initial Value of Next Awake Notification Power]

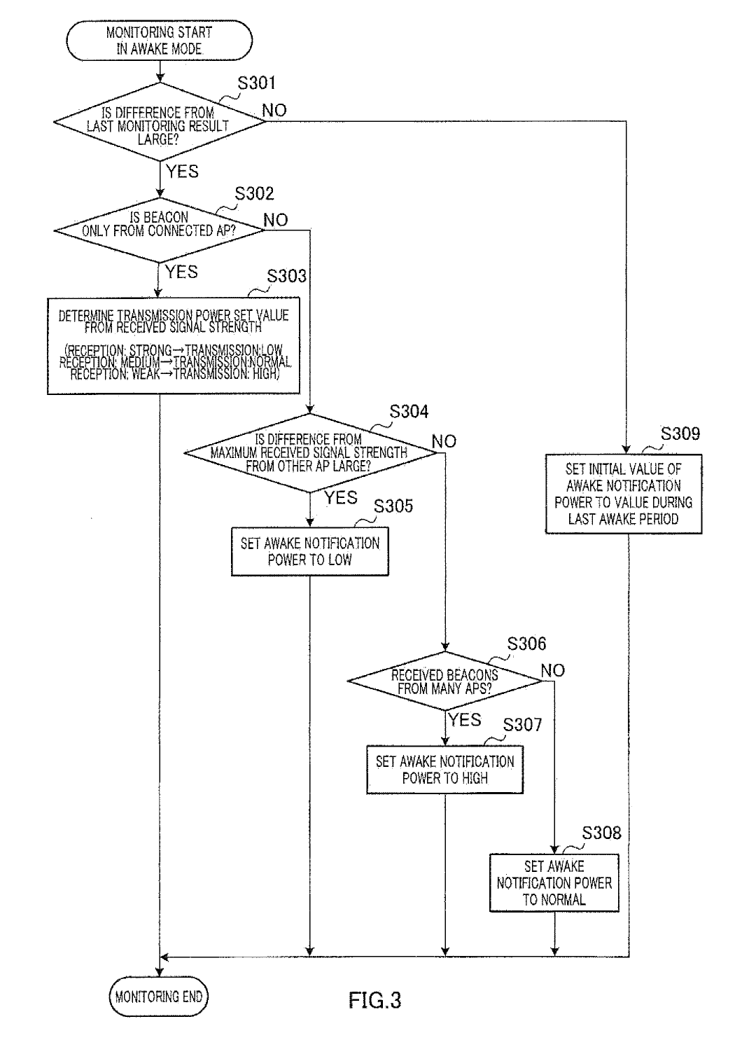

FIG. 3 is a diagram illustrating a flow for radio communication apparatus 100 to determine an initial value to set the next awake notification power based on received signal quality of a beacon signal received from an AP during an awake period.

Receiving quality recording section 120 monitors and records received signal quality of a beacon signal from an AP in the periphery that can be received for an awake period. Fluctuation determining section 130 calculates a difference in received signal quality (inter-AP receiving quality difference) between a connected AP and an AP other than the connected AP. Fluctuation determining section 130 then determines whether the inter-AP receiving quality difference this time has significantly fluctuated from the inter-AP receiving quality difference acquired during the last awake period or not (S301). That is, fluctuation determining section 130 determines whether a combination of “received signal quality from the connected AP and received signal quality from the other AP” has significantly fluctuated or not. When the connected AP is changed or when there is no other AP as well, the difference has significantly fluctuated.

When the inter-AP receiving quality difference has not substantially changed between this time and last time (S301: NO), initial value setting section 150 sets the transmission power used during the last awake period as an initial value of the next awake notification power (S309). This makes it possible to reduce the amount of calculation required to set the initial value.

On the other hand, when the inter-AP receiving quality difference this time differs from last time (S301: YES), fluctuation determining section 130 refers to the entry of receiving quality recording section 120. Fluctuation determining section 130 determines, from the entry, whether a beacon signal is obtained only from the connected AP or not (S302). Fluctuation determining section 130 notifies initial value setting section 150 of the determination result.

When radio communication apparatus 100 has received a beacon signal only from the connected AP (S302: YES), initial value setting section 150 sets awake notification power according to the received signal strength from the connected AP (S303). For example, initial value setting section 150 selects the awake notification power from three levels according to the received signal strength from the connected AP. To be more specific, when the received signal strength from the connected AP is strong, initial value setting section 150 sets the awake notification power to low. On the other hand, when the received signal strength from the connected AP is medium strength, initial value setting section 150 sets the awake notification power to normal. When the received signal strength from the connected AP is weak, initial value setting section 150 sets the awake notification power to high.

When radio communication apparatus 100 is receiving beacon signals from a plurality of APs (S302: NO), fluctuation determining section 130 determines the magnitude of difference between a maximum value of the received signal strength from an AP other than the connected AP and the received signal strength from the connected AP (S304). Hereinafter, the difference will be referred to as a minimum inter-AP receiving quality difference.

When the minimum inter-AP receiving quality difference is large (S304: YES), initial value setting section 150 sets the awake notification power to low (S305).

In contrast, when the minimum inter-AP receiving quality difference is small (S304: NO), initial value setting section 150 determines whether radio communication apparatus 100 has received beacon signals from many APs other than the connected AP or not (S306). For example, initial value setting section 150 compares the number, which is predetermined, of APs with the number of APs other than the connected AP that transmitted the beacon signal received by radio communication apparatus 100 to thereby make the determination in step S306.

When radio communication apparatus 100 has received beacon signals from many APs (S306: YES), initial value setting section 150 sets the awake notification power to high (S307). When radio communication apparatus 100 has received beacon signals from many APs, many wireless LAN terminals are assumed to be operating. In this case, if radio communication apparatus 100 continues communication with the transmission signal set to low, other wireless LAN terminals cannot detect the transmission signal from radio communication apparatus 100 by regarding it as an interference signal, increasing the possibility that radio signals may collide with each other. When radio communication apparatus 100 has received beacon signals from many APs, the aforementioned collision between radio signals can be prevented by setting the awake notification power to high and increasing transmission power during communication.

On the other hand, when radio communication apparatus 100 has not received beacon signals from many APs (S306: NO), initial value setting section 150 sets the awake notification power to normal value (S308).

Thus, radio communication apparatus 100 determines an initial value of the next awake notification power based on the received signal quality of the beacon signal received from the AP during the awake period.

The flow shown in FIG. 3 has shown an example where initial value setting section 150 sets the initial value of the awake notification power to one of three levels (high, normal, low). However, without being limited to this, initial value setting section 150 may also set the set value of the awake notification power in two levels or four or more levels.

Furthermore, an example has been described in step S304 shown in FIG. 3 where fluctuation determining section 130 determines the magnitude of the difference between the maximum value of the received signal strength from an AP other than the connected AP and the received signal strength from the connected AP (minimum inter-AP receiving quality difference) in two levels, i.e., whether the magnitude is large or small. However, without being limited to this, fluctuation determining section 130 may determine the magnitude of the minimum inter-AP receiving quality difference, for example, in three or more levels. Furthermore, in step S306, initial value setting section 150 may set the predetermined number of APs to, for example, 5, 10 or 15 as a threshold as appropriate.

[Determining Awake Notification Power this Time and Transmission Power During Communication]

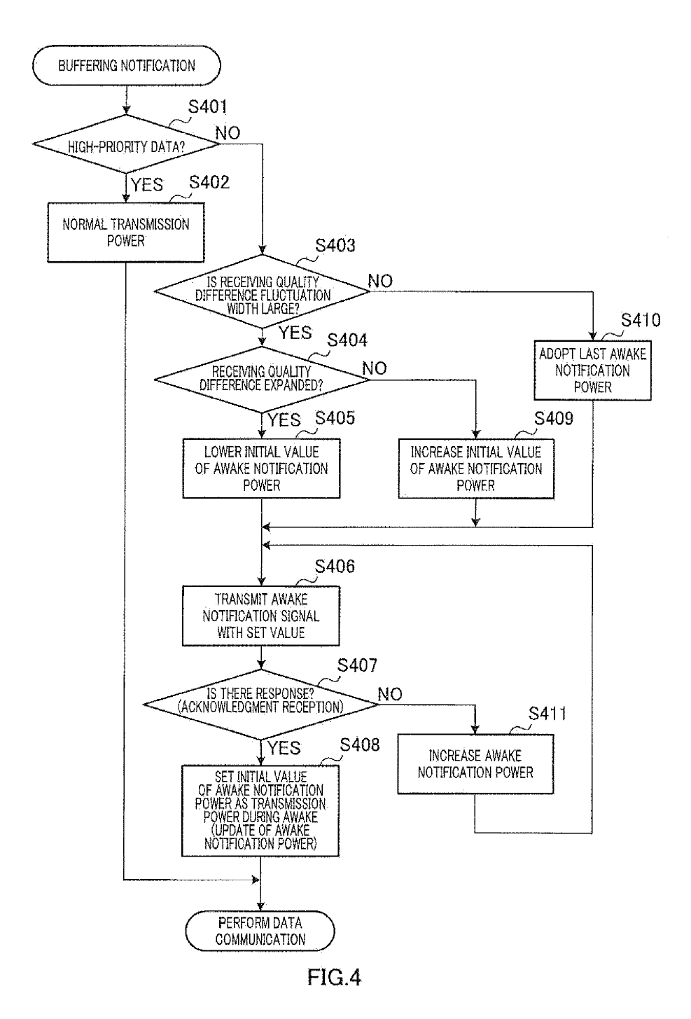

FIG. 4 is a diagram illustrating a flow for radio communication apparatus 100 to finally determine awake notification power for an awake period this time and transmission power during communication. Radio communication apparatus 100 sets awake notification power this time and transmission power during communication based on the fluctuation width of received signal quality of a beacon signal received from an AP for the awake periods this time and last time and an initial value of the awake notification power.

When radio communication apparatus 100 receives, from the AP, a beacon signal indicating that data addressed to radio communication apparatus 100 is buffered, mode management section 140 determines, based on the beacon signal, whether the buffered data is high-priority data or not (S401).

When the buffered data in the AP is high-priority data (S401: YES), radio communication apparatus 100 sets the awake notification power as normal transmission power (S402). The normal transmission power here is power preset as transmission power expected to allow the AP to reliably perform reception regardless of the communication environment. For example, as shown in FIG. 3, when the transmission power is set to one of three levels (high, normal, low), it is assumed that the normal transmission power is set to a level “high” which is the largest among the levels that can be set.

On the other hand, when the data buffered in the AP is not high-priority data (S401: NO), fluctuation determining section 130 determines whether the fluctuation width between the inter-AP receiving quality difference last time and the inter-AP receiving quality difference this time is large or not (S403). Here, the inter-AP receiving quality difference is the difference between the received signal quality from the connected AP and the received signal quality from an AP other than the connected AP. Hereinafter, the fluctuation width between the inter-AP receiving quality difference last time and the inter-AP receiving quality difference this time will be referred to as “difference fluctuation width.”

In the determination in step S403, there may be a case where the period for monitoring received signal qualities is too short to receive beacon signals from all APs in the periphery. For that reason, fluctuation determining section 130 compares only the received signal qualities of beacon signals that could be acquired until the time at which an awake notification signal is transmitted and determines whether the difference fluctuation width is large or not.

When the difference fluctuation width is not large (S403: NO), initial value setting section 150 sets the initial value of the awake notification power set for the last awake period as the transmission power (S410).

When the difference fluctuation width is large (S403: YES), fluctuation determining section 130 determines whether the difference fluctuation width has expanded or not (S404).

When the difference fluctuation width has expanded (S404: YES), initial value setting section 150 determines that a communication environment with respect to the connected AP has improved. In this case, initial value setting section 150 adjusts the initial value of the awake notification power to a lower value (S405).

On the other hand, when the difference fluctuation width has not expanded (S404: NO), initial value setting section 150 determines that the communication environment with respect to the connected AP has deteriorated. In this case, initial value setting section 150 adjusts the initial value of the awake notification power to a higher value (S409).

After setting the initial value of the awake notification power, initial value setting section 150 notifies transmission power determining section 170 of information of the set initial value of the awake notification power. Transmission power determining section 170 instructs transmission power control section 180 to transmit an awake notification signal with the set initial value of the awake notification power. Thus, radio transmitting section 190 transmits the awake notification signal to the connected AP with the instructed awake notification power (S406).

Next, response confirmation section 160 confirms whether an acknowledgment signal for the awake notification signal has been received or not (S407).

When the acknowledgment signal for the awake notification signal has been received (S407: YES), transmission power determining section 170 sets transmission power of data transmission and control signal transmission (transmission power of communication) during this awake period to the awake notification power. Furthermore, transmission power determining section 170 updates the initial value of the awake notification power using the transmission power as the initial value of the awake notification power (S408).

On the other hand, when the acknowledgment signal for the awake notification signal has not been received (S407: NO), transmission power determining section 170 sets the awake notification power to a higher value (S411).

The awake notification signal is transmitted again with the reset awake notification power (S406).

Thus, radio communication apparatus 100 can adjust the awake notification power this time and transmission power during communication to optimum values based on the fluctuation width in received signal quality for the awake period between last time and this time and on the initial value of the awake notification power.

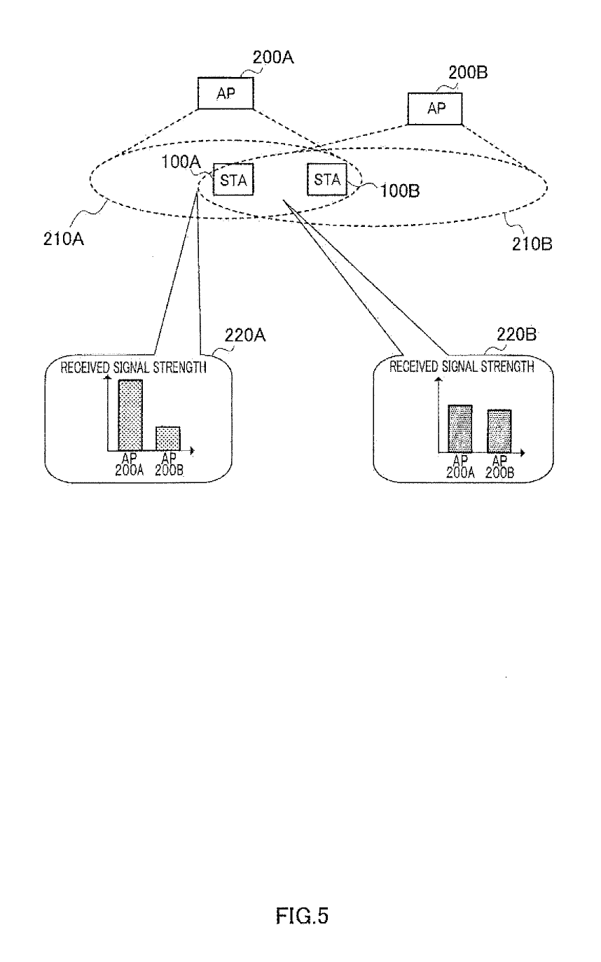

FIG. 5 is a diagram illustrating an example of a network configuration according to the present embodiment. The configuration example shown in FIG. 5 is an example where APs 200A and 200B are installed, and radio communication apparatuses (STA) 100A and 100B are both connected to AP 200A. Here, radio communication apparatus 100A or 100B adopts a configuration similar to that of radio communication apparatus 100 in FIG. 1.

Furthermore, APs 200A and 200B have their respective service areas connectable to the radio communication apparatuses. In FIG. 5, service area 210A is a service area of AP 200A and service area 210B is a service area of AP 200B.

In FIG. 5, received signal strength 220A indicates received signal strengths of APs 200A and 200B recorded in receiving quality recording section 120 of radio communication apparatus 100A. Furthermore, received signal strength 220B indicates received signal strengths of APs 200A and 200B recorded in receiving quality recording section 120 of radio communication apparatus 100B.

Radio communication apparatus 100A is located close to AP 200A and far from AP 200B. As indicated by received signal strength 220A, the received signal strength from AP 200A is large and the received signal strength from AP 200B is small. For this reason, there is a large difference between receiving qualities from the respective APs, and radio communication apparatus 100A sets the initial value of the awake notification power to “low” according to the flow shown in FIG. 3.

Radio communication apparatus 100B is located at substantially the same distance from AP 200A and AP 200B. As indicated by received signal strength 220B, the received signal strength from AP 200A is at substantially the same level as the received signal strength from AP 200B. For this reason, the difference between the receiving qualities from the respective APs is small, and radio communication apparatus 100B sets the initial value of the awake notification power to “high” according to the flow shown in FIG. 3.

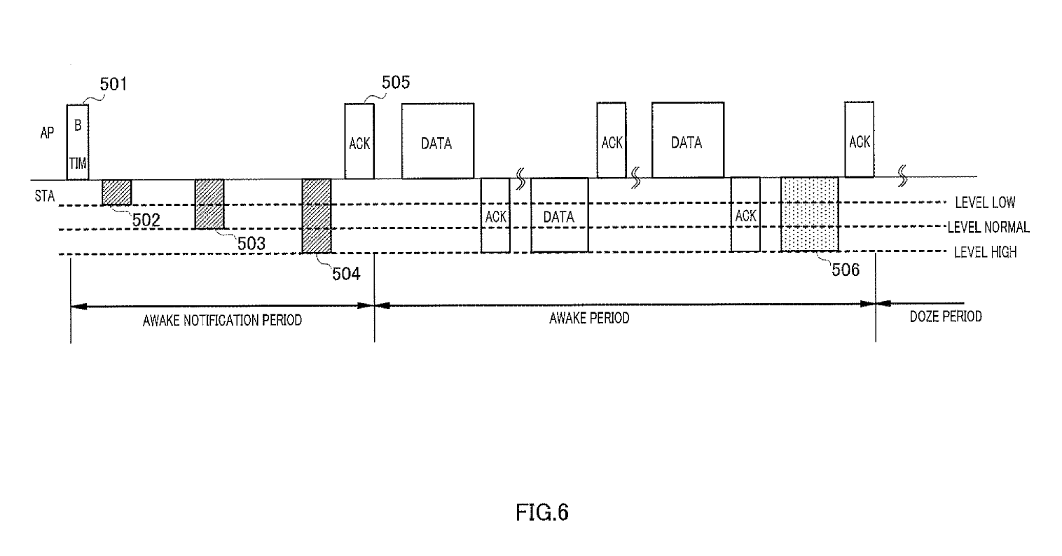

FIG. 6 is a diagram illustrating a sequence example when radio communication apparatus 100A shown in FIG. 5 communicates with AP 200A. FIG. 6 shows an example of a case where the communication environment temporarily deteriorates in a situation in which radio communication apparatus 100A sets the initial value of the awake notification power to “low” during the last awake period.

Upon receiving, from AP 200A, beacon 501 storing information indicating that data addressed to radio communication apparatus 100A is buffered, radio communication apparatus 100A shifts to an awake notification period. Radio communication apparatus 100A sets the initial value of the awake notification power to “. low” according to the flow in FIG. 3. When the difference fluctuation width is small, radio communication apparatus 100A transmits awake notification signal 502 with level “low.” Here, the difference fluctuation width is a fluctuation width between the inter-AP receiving quality differences last time and this time. Furthermore, the inter-AP receiving quality difference is a difference between the received signal quality from the connected AP and the received signal quality from an AP other than the connected AP.

However, when the communication environment drastically deteriorates, radio communication apparatus 100A may not be able to receive an acknowledgment signal for awake notification signal 502.

When radio communication apparatus 100A cannot receive an acknowledgment signal, radio communication apparatus 100A increases the awake notification power according to the flow in FIG. 4 and transmits awake notification signal 503 again. If the acknowledgment signal cannot be received in that case either, radio communication apparatus 100A further increases the awake notification power to level “high” and transmits awake notification signal 504 again.

Here, upon receiving acknowledgment signal (ACK) 505 from AP 200A, radio communication apparatus 100A transmits data and a control signal using level “high” as the transmission power for the awake period.

In a situation such as when AP 200A has no buffered data addressed to radio communication apparatus 100A or when there is no transmission data from radio communication apparatus 100A, radio communication apparatus 100A transmits doze notification signal 506. At this time, radio communication apparatus 100A transmits doze notification signal 506 using transmission power (level “high”) during communication used for the awake period.

Upon receiving an acknowledgment signal for doze notification signal 506 from AP 200A, radio communication apparatus 100A shifts to a doze mode and enters a power-saving state.

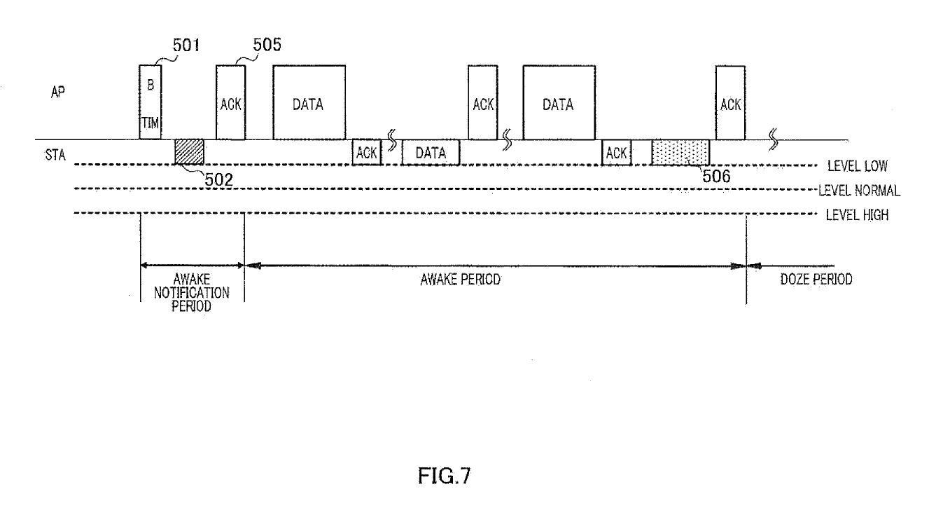

FIG. 6 has shown a sequence example where after transmitting awake notification signal 504 using level “high,” radio communication apparatus 100A has received an acknowledgment signal. When radio communication apparatus 100A receives an acknowledgment signal for awake notification signal 502 transmitted using level “low,” radio communication apparatus 100A transmits data and a control signal using level “low” as the transmission power thereof for the awake period. FIG. 7 is a sequence example where after transmitting awake notification signal 502 using level “low,” radio communication apparatus 100A has received an acknowledgment signal.

Furthermore, when the fluctuation width (difference fluctuation width) between the inter-AP receiving quality differences last time and this time at the start of the awake notification period is large and has not expanded (not improved), radio communication apparatus 100A increases the awake notification power from level “low” to “normal.” Radio communication apparatus 100A then transmits awake notification signal 503 using level “normal.”

Through such processing, radio communication apparatus 100A monitors received signal quality from an AP in the periphery during the awake period. When shifting from the doze mode to the awake mode again, radio communication apparatus 100A makes an appropriate transmission power setting according to the difference between the received signal quality from the connected AP and received signal quality from an AP in the periphery other than the connected AP.

To be more specific, receiving quality recording section 120 records first receiving quality which is received signal quality from the connected AP and second receiving quality which is received signal quality from the AP other than the connected AP while operating in an awake mode (normal power mode). Fluctuation determining section 130 determines the difference between the first receiving quality and the second receiving quality. Initial value setting section 150 sets an initial value of transmission power of an awake notification signal transmitted when starting operation in the next awake mode (normal power mode), based on the difference between the first receiving quality and the second receiving quality. This allows radio communication apparatus 100 to appropriately set transmission power during the awake period without providing any special period for monitoring the surrounding communication environment. As a result, every time radio communication apparatus 100 shifts from this doze mode to the awake mode, radio communication apparatus 100 can set appropriate transmission power according to the reception situation. This allows radio communication apparatus 100 to prevent communication with excessive transmission power, and thereby suppress power consumption in the radio communication apparatus.

A case has been described above where receiving quality recording section 120 uses received signal strength of a beacon signal from an AP as received signal quality, but the claimed invention is not limited to this. Receiving quality recording section 120 may monitor data frames for a certain period and determine received signal quality based on an error rate thereof, a retransmission rate of data frames, or the like, and store the received signal quality.

Furthermore, fluctuation determining section 130 may determine the difference based on the received signal quality from another radio communication apparatus connected to another AP and determine awake notification power.

Furthermore, in the above description, to determine the actual awake notification power, radio communication apparatus 100 determines receiving quality when shifting to the awake mode in S403, Thus, according to the determination result, radio communication apparatus 100 may be configured so as not to shift to the awake mode. For example, when the received signal quality from the connected AP is poor or when the inter-AP receiving quality difference is small, radio communication apparatus 100 may be configured so as not to shift to the awake mode. This allows radio communication apparatus 100 to prevent communication when the communication environment is poor.

Furthermore, in the above description, radio communication apparatus 100 determines the actual awake notification power when shifting to the awake mode. At this time, radio communication apparatus 100 may set an upper limit value and a lower limit value of the awake notification power according to the management mode of the connected AP. For example, when the connected AP is set inside a house, radio communication apparatus 100 may be configured to lower the upper limit value of the awake notification power. Alternatively, when the user manages radio communication apparatus 100 and the area where the user uses radio communication apparatus 100 is limited, radio communication apparatus 100 may be configured to lower the upper limit value of the awake notification power. This prevents transmission power from being set to an excessively high value when an unspecified number of users do not use communication apparatus 100.

Furthermore, when the connected AP is managed, for example, by a service provider like a free spot (hot spot) or by an in-house wireless LAN system, radio communication apparatus 100 may set a high value as the lower limit value of the awake notification power. This makes it possible to prevent transmission power from being excessively lowered to thereby decrease transmission priority to a significantly lower level than transmission priority of an unspecified number of users.

### Embodiment 2

A radio communication apparatus according to Embodiment 1 sets an initial value of the next awake notification power during an awake period. When notifying an AP of a shift to a doze mode, the radio communication apparatus according to the present embodiment further has a function of changing transmission power of a doze notification signal (hereinafter referred to as “doze notification power”) to thereby determine an initial value of the next awake notification power.

Since the basic configuration of the radio communication apparatus according to the present embodiment is common to that of Embodiment 1, the present embodiment will be described using FIG. 1.

Since processing upon shifting to an awake mode is similar to that in Embodiment 1, description thereof will be omitted, and processing upon shifting from an awake mode to a doze mode will be mainly described.

When shifting to the doze mode, mode management section 140 instructs initial value setting section 150 to determine transmission power of a doze notification signal (doze notification power).

Upon receiving an instruction from mode management section 140 so as to determine doze notification power, initial value setting section 150 sets the doze notification power. To be more specific, initial value setting section 150 sets the doze notification power based on information on a fluctuation width between an inter-AP receiving quality difference during transmission of an awake notification signal acquired from fluctuation determining section 130 and a latest inter-AP receiving quality difference (hereinafter referred to as “latest difference fluctuation width”). Here, the inter-AP receiving quality difference is a difference between received signal quality from a connected AP and received signal quality from an AP other than the connected AP. More specifically, when the latest difference fluctuation width has expanded, that is, when the communication environment has improved, initial value setting section 150 sets the doze notification power to a value lower than the transmission power during communication. Initial value setting section 150 outputs information of the set doze notification power to transmission power determining section 170.

Transmission power determining section 170 instructs transmission power control section 180 to transmit a doze notification signal with the doze notification power set in initial value setting section 150.

When response confirmation section 160 obtains, from the connected AP, an acknowledgment signal corresponding to the doze notification signal transmitted with the determined doze notification power, initial value setting section 150 updates the initial value of the awake notification power. To be more specific, initial value setting section 150 updates an initial value of awake notification power using, as an initial value of the next awake notification power, transmission power of the doze notification signal with which an acknowledgment signal is obtained (doze notification power).

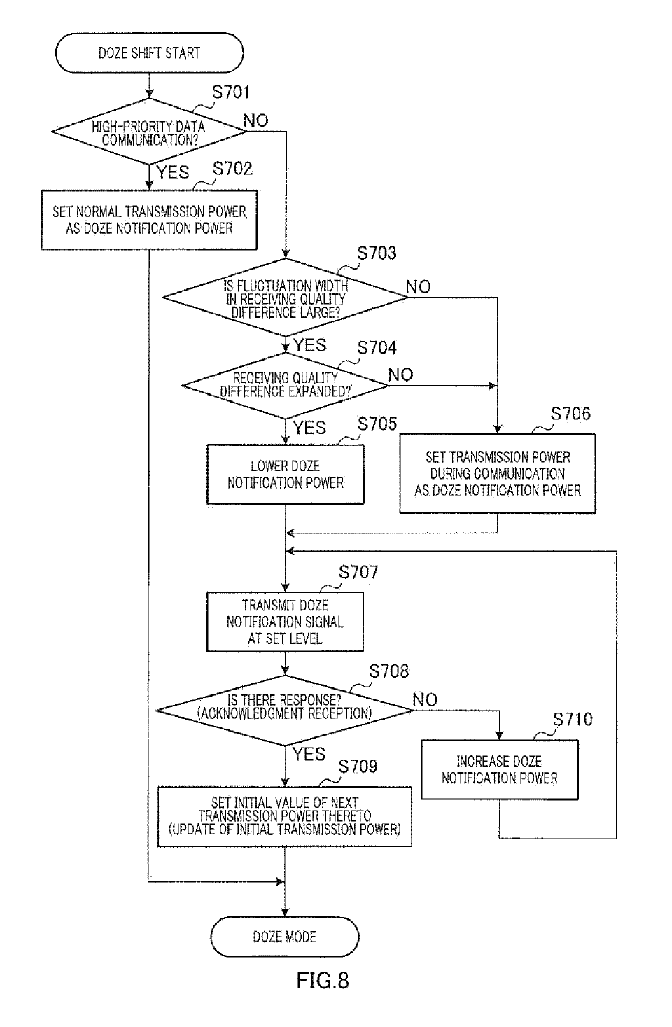

FIG. 8 is a diagram illustrating a processing flow until radio communication apparatus 100 shifts from an awake mode to a doze mode.

Based on no data to be transmitted by radio communication apparatus 100, no data from an AP, or the like, mode management section 140 detects a shift to a doze mode. Upon detecting the shift to the doze mode, mode management section 140 determines whether high-priority data has been communicated during communication or not (S701).

When it is determined that high-priority data has been communicated (S701: YES), mode management section 140 instructs initial value setting section 150 to set doze notification power to preset normal transmission power. Initial value setting section 150 sets the normal transmission power as the doze notification power (S702). This causes radio communication apparatus 100 to transmit a doze notification signal with normal transmission power. When immediately preceding communication data is high-priority data and a communication session thereof is not ended, high-priority data is also communicated for the next awake period. Thus, by executing the processing in S702, it is possible to transmit an active notification signal with normal transmission power for the next awake period and perform communication with normal power.

When high-priority data has not been communicated (S701: NO), receiving quality recording section 120 monitors and records the latest received signal quality. Fluctuation determining section 130 then determines whether a fluctuation width between the inter-AP receiving quality difference at the awake notification signal transmission and the latest inter-AP receiving quality difference (latest difference fluctuation width) is large or not (S703). Here, the inter-AP receiving quality difference is a difference between the received signal quality from the connected AP and the received signal quality from an AP other than the connected AP.

When the latest difference fluctuation width is small (S703: NO), initial value setting section 150 sets the transmission power during communication to doze notification power (S706).

On the other hand, when the latest difference fluctuation width is large (S703: YES), fluctuation determining section 130 further determines whether the latest difference fluctuation width has expanded or not (S704).

When the latest difference fluctuation width has expanded (S704: YES), initial value setting section 150 determines that the communication environment with respect to the connected AP has improved. In this case, initial value setting section 150 sets the doze notification power to a value lower than the transmission power during communication (S705).

On the other hand, when the latest difference fluctuation width has diminished (S704: NO), initial value setting section 150 sets the transmission power during communication to the doze notification power (S706)).

When the doze notification power is determined in initial value setting section 150, information on the doze notification power is notified of to transmission power determining section 170. Transmission power determining section 170 instructs transmission power control section 180 to transmit a doze notification signal with the set doze notification power, and the doze notification signal is transmitted to the connected AP (S707).

Next, response confirmation section 160 confirms whether an acknowledgment signal in response to the doze notification signal has been received or not (S708).

When an acknowledgment signal in response to the doze notification signal has been received (S708: YES), transmission power determining section 170 sets the doze notification power as an initial value of the awake notification power and updates the awake notification power (S709).

On the other hand, when an acknowledgment signal in response to the doze notification signal has not been received (S708: NO), transmission power determining section 170 adjusts the doze notification power to a higher value (S710).

A doze notification signal is then transmitted again with the reset doze notification power (S707).

After setting the transmission power during an awake period (transmission power during communication) through such processing, radio communication apparatus 100 monitors the latest received signal quality from an AP in the periphery when shifting to a doze mode. Radio communication apparatus 100 then sets appropriate doze notification power based on the fluctuation width between the inter-AP receiving quality difference during awake notification signal transmission and the latest inter-AP receiving quality difference (latest difference fluctuation width). Radio communication apparatus 100 uses the set doze notification power as an initial value of the next awake notification power. Even when the communication environment fluctuates during communication, this allows radio communication apparatus 100 to appropriately set transmission power during the next awake period.

In the above description, radio communication apparatus 100 determines doze notification power when shifting to the doze mode. At this time, radio communication apparatus 100 may set an upper limit value or a lower limit value of doze notification power according to a management mode of the connected AP. For example, when the connected AP is installed in a house or when the user manages the radio communication apparatus, radio communication apparatus 100 may be configured to lower the upper limit value of the doze notification power. This makes it possible to prevent the transmission power from being set to an excessively high value even when an unspecified number of users do not use radio communication apparatus 100. Furthermore, when the connected AP is managed, for example, by a service provider like a free spot (hot spot) or by an in-house wireless LAN system, radio communication apparatus 100 may set a high value as the lower limit value of the doze notification power. In this case, it is possible to prevent transmission power from being excessively lowered to thereby decrease transmission priority to a significantly lower level than transmission priority of an unspecified number of users.

Furthermore, a case has been described in Embodiment 1 and Embodiment 2 as an example where radio communication apparatus 100 uses a wireless LAN, but the claimed invention is not limited to this. The claimed invention is applicable to any radio system such as Bluetooth, Zigbee, and WiMAX without being limited to a wireless LAN, as long as it has an awake mode and a doze mode as operating modes and has a system mode in which radio communication is performed in the awake mode.

Furthermore, the portion enclosed by a dotted line in FIG. 1 which is a block diagram common to the respective embodiments is implemented as an LSI (Large Scale Integration) which is an integrated circuit. To be more specific, the portion implemented by the LSI include, for example, receiving quality recording section 120, fluctuation determining section 130, initial value setting section 150, mode management section 140, response confirmation section 160, transmission power determining section 170 and transmission power control section 180. These may be individual chips or partially or totally contained on a single chip. Furthermore, these may be integrated into a single chip including the digitized portion in radio receiving section 110 and radio transmitting section 190.

The term “LSI” is adopted herein but this may also be referred to as “IC (Integrated Circuit),” “system LSI,” “super LSI,” or “ultra LSI” depending on the differing extents of integration.

Further, in the radio communication apparatus according to the embodiments, the method of implementing integrated circuit is not limited to LSI, and implementation by means of dedicated circuitry or a general-purpose processors may also be possible. After LSI manufacture, utilization of a programmable gate array (Field Programmable Gate Array) or a reconfigurable processor where connections and settings of circuit cells within an LSI can be reconfigured is also possible.

If a new integrated circuit implementation technology replacing LSI is introduced because of advancement in semiconductor technology or a different technology derived therefrom, the function blocks of the radio communication apparatus according to the above embodiments may of course be integrated using that technology. For example, application of biotechnology is possible for the radio communication apparatus according to the above embodiments.

Although radio communication apparatus 100 has been described in Embodiment 1 and Embodiment 2 as a single radio communication apparatus, a configuration may also be adopted in which radio communication apparatus 100 is incorporated in a mobile phone, storage/reproducing apparatus, digital television, vehicle-mounted equipment, personal computer or the like.

The disclosure of Japanese Patent Application No. 2010-227695, filed on Oct. 7, 2010, including the specification, drawings and abstract is incorporated herein by reference in its entirety.

### INDUSTRIAL APPLICABILITY

The claimed invention is useful as a radio communication apparatus such as a wireless LAN card or wireless LAN module, or a radio communication method and a processing circuit used therefor. Furthermore, the radio communication apparatus, radio communication method and processing circuit according to the claimed invention can also be used for a personal computer, tablet type terminal, mobile phone or the like with a built-in wireless LAN device.

### REFERENCE SIGNS LIST

100, 100A, 100B Radio communication apparatus
110 Radio receiving section
120 Receiving quality recording section
130 Fluctuation determining section
140 Mode management section
150 Initial value setting section
160 Response confirmation section
170 Transmission power determining section
180 Transmission power control section
190 Radio transmitting section
200A, 200B Access point

1. A radio communication apparatus that operates in a low power mode during no communication and operates in a normal power mode when there is data to be received or transmitted, comprising:
a recording section that records first receiving quality which is received signal quality from a connected access point during operation in the normal power mode and second receiving quality which is received signal quality from an access point other than the connected access point;
a determining section that determines a difference between the first receiving quality and the second receiving quality; and
a setting section that sets an initial value of transmission power of an awake notification signal transmitted when starting operation in the next normal power mode based on the difference.

2. The radio communication apparatus according to claim 1, further comprising a transmission power determining section that determines transmission power of the awake notification signal that enables a response from the connected access point as the transmission power in the normal power mode.

3. The radio communication apparatus according to claim 1, wherein the setting section modifies the initial value to a smaller value when shifting from the low power mode to the normal power mode and when the latest difference determined by the determining section is improved from the last difference.

4. The radio communication apparatus according to claim 1, wherein the setting section further sets, when shifting from the normal power mode to the low power mode and when the latest difference calculated by the determining section is improved from the last difference, transmission power of a doze notification signal notifying the shift to the low power mode to a value smaller than the transmission power in the normal power mode.

5. A radio communication method for a radio communication apparatus that operates in a low power mode during no communication and operates in a normal power mode when there is data to be received or transmitted, the method comprising:
recording first receiving quality which is received signal quality from a connected access point during operation in the normal power mode and second receiving quality which is received signal quality from an access point other than the connected access point;
determining a difference between the first receiving quality and the second receiving quality; and
setting an initial value of transmission power of an awake notification signal transmitted when starting operation in the next normal power mode based on the difference.

6. A radio communication method for a radio communication apparatus that operates in a low power mode during no communication and operates in a normal power mode when there is data to be received or transmitted, the method comprising:
recording first receiving quality which is received signal quality from a connected access point during operation in the normal power mode and second receiving quality which is received signal quality from an access point other than the connected access point;
determining a difference between the first receiving quality and the second receiving quality;
setting an initial value of transmission power of an awake notification signal transmitted when starting operation in the normal power mode based on the difference;
determining transmission power of the awake notification signal that enables a response from the connected access point as transmission power in the normal power mode; and
modifying an initial value of transmission power of an awake notification signal transmitted when starting operation in the next normal power mode to a smaller value when the difference between the first receiving quality and the second receiving quality is improved from the last difference.

7. A processing circuit of a radio communication apparatus that operates in a low power mode during no communication and operates in a normal power mode when there is data to be received or transmitted, comprising:
a section that records first receiving quality which is received signal quality from a connected access point during operation in the normal power mode and second receiving quality which is received signal quality from an access point other than the connected access point;
a section that determines a difference between the first receiving quality and the second receiving quality; and
a section that sets an initial value of transmission power of an awake notification signal transmitted when starting operation in the normal power mode, wherein:
the processing circuit performs control of modifying an initial value of transmission power of a next awake notification signal based on the difference between the first receiving quality and the second receiving quality.
